(19) United States
(12) Patent Application Publication
(10) Pub. No.: US 2013/0204924 A1
(43) Pub. Date: Aug. 8, 2013

(54) METHODS AND APPARATUSES FOR PROVIDING APPLICATION LEVEL DEVICE TRANSPARENCY VIA DEVICE DEVIRTUALIZATION

(71) Applicants: Sreekumar Ramakrishnan Nair, San Jose, CA (US); Quinn Able Jacobson, Sunnyvale, CA (US)

(72) Inventors: Sreekumar Ramakrishnan Nair, San Jose, CA (US); Quinn Able Jacobson, Sunnyvale, CA (US)

(73) Assignee: Nokia Corporation, Espoo (FI)

(21) Appl. No.: 13/365,632

(22) Filed: Feb. 3, 2012

(51) Int. Cl. G06F 15/16

(52) U.S. Cl. 709/203

(57) ABSTRACT

Methods and apparatuses are provided for providing application level device transparency via device devirtualization. A method may include providing a devirtualization server driver on a host system. The method may further include receiving, at the devirtualization server driver, a request from a devirtualization client driver on a guest system for access to a physical device implemented on the host system. The request may be associated with a guest application on the guest system. The method may additionally include causing the guest application to be provided with access to directly control the device as if the device were present on the guest system without implementing a driver specific to the device on the guest system. Control of the device may be concurrently shared between the guest application and the host system. A corresponding apparatus is also provided.

### TECHNOLOGICAL FIELD

Example embodiments of the present invention relate generally to computing technology and, more particularly, relate to methods and apparatuses for providing application level device transparency via device devirtualization.

### BACKGROUND

The modern computing era has brought about a tremendous expansion in computing power resulting in a reduction in the size of computing devices, as well as a significant reduction in the cost per unit of computing power. Today's mobile devices are even capable of performing functionality that only a few years ago required processing power provided only by the most advanced desktop computers. Consequently, computing devices, such as mobile computing devices, having a relatively small form factor have become ubiquitous and are used to access network applications and services by consumers of all socioeconomic backgrounds.

In spite of this expansion in computing power and increasing ubiquity of computing devices, there is still an unsatisfied demand for additional computing resources. One solution that is being used to attempt to satisfy the demand for additional computing resources is leveraging the power of modern computing hardware to implement virtualized systems (e.g., virtual machines) on an underlying physical machine. In this regard, a virtual machine may comprise an emulated machine running in software on top of an underlying physical machine. The virtual machine may provide its own execution platform, which may appear to be an independent physical computing platform to a user.

Many highly sophisticated applications, such as graphics engines (e.g., X11 server), may know how to best exploit hardware optimizations for a device, provided that the device is present on the system and the correct drivers for the device are loaded. However, if such an application were to be physically separated from the physical hardware devices, as would happen when the applications are run in a virtualized environment (e.g., a guest operating system running on a hypervisor), the application may not realize the same level of performance or functionality as in an instance in which the application were to be run directly on the hardware level system. In this regard, the virtual devices configured for the guest system may provide only some basic (e.g., least common denominator) functionality, and the application may accordingly tune itself to the configuration of these basic virtual devices and scale down on optimizations and functionality.

### BRIEF SUMMARY

Methods, apparatuses, and computer program products are herein provided for providing application level device transparency. Methods, apparatuses, and computer program products in accordance with various embodiments may provide several advantages to computing devices, computing device users, hardware developers, and application developers. Some example embodiments provide for application level device transparency via device devirtualization. In this regard, some example embodiments provide for devirtualization of a device such that a guest application operating on a guest system may be provided with access to directly control a device on a host system as if the device were present on the guest system, rather than having to use a virtualized device on the guest system. In accordance with some such example embodiments, control of the device is concurrently shared between the guest application and the host system such that the guest application is not directly assigned the device at the expense of the host system. In this regard, some example embodiments provide an end-user with an option to enable guest applications to directly control hardware devices on the host system and to exploit functionality and optimizations offered by the hardware device, without interfering with the ability of the host system to use and control the device. Accordingly, in accordance with some example embodiments, device devirtualization may be device agnostic in that loading of device-specific drivers on a guest system may not be needed; may allow a guest application to control a device on the host system as if the device were present on the guest system without requiring modification of the guest application; and may allow for a device on the host system to be concurrently shared between guest applications and applications on the host system.

Accordingly, from the perspective of a guest application, some example embodiments provide for application level device transparency via device devirtualization such that a guest application may be provided with application level device transparency across a virtualized domain(s). In some example embodiments, a guest application may obtain device performance substantially approximate to native performance that would be provided if the device on the host system were actually implemented on the guest system. From the perspective of the host system of some example embodiments, the impact of sharing the use of its hardware device with the guest application may be limited, as the impact of sharing use of the hardware device with the guest application may be viewed as being similar to the concurrent use of the device by its own applications (e.g., applications on the host system). Further, some example embodiments do not require implementation of a device-specific driver on the guest system, instead leveraging device drivers on the host system that are configured to synchronize and co-ordinate the device operations from multiple application domains. Accordingly, unlike techniques such as device pass-through (or direct assignment of devices), where the guest application gets exclusive ownership of a device, some example embodiments allow one or more guest applications and the host system to share devices concurrently, without significantly impacting either device performance or usage of the device by the host system.

In a first example embodiment, a method is provided, which may comprise providing a devirtualization server driver on a host system. The method of this example embodiment may further comprise receiving, at the devirtualization server driver, a request from a devirtualization client driver on a guest system for access to a physical device implemented on the host system. The request of this example embodiment may be associated with a guest application on the guest system. The method of this example embodiment may additionally comprise causing the guest application to be provided with access to directly control the device as if the device were present on the guest system without implementing a driver specific to the device on the guest system. Control of the device in this example embodiment may be concurrently shared between the guest application and the host system.

In another example embodiment, an apparatus comprising at least one processor and at least one memory storing computer program code is provided. The at least one memory and stored computer program code may be configured, with the at least one processor, to cause the apparatus of this example embodiment to at least provide a devirtualization server driver on a host system. The at least one memory and stored computer program code may be configured, with the at least one processor, to further cause the apparatus of this example embodiment to receive, at the devirtualization server driver, a request from a devirtualization client driver on a guest system for access to a physical device implemented on the host system. The request of this example embodiment may be associated with a guest application on the guest system. The at least one memory and stored computer program code may be configured, with the at least one processor, to additionally cause the apparatus of this example embodiment to cause the guest application to be provided with access to directly control the device as if the device were present on the guest system without implementing a driver specific to the device on the guest system. Control of the device in this example embodiment may be concurrently shared between the guest application and the host system.

In another example embodiment, a computer program product is provided. The computer program product of this example embodiment includes at least one computer-readable storage medium having computer-readable program instructions stored therein. The program instructions of this example embodiment may comprise program instructions, which when performed by an apparatus, are configured to cause the apparatus to at least provide a devirtualization server driver on a host system. The program instructions of this example embodiment may further comprise program instructions, which when performed by an apparatus, are configured to cause the apparatus to receive, at the devirtualization server driver, a request from a devirtualization client driver on a guest system for access to a physical device implemented on the host system. The request of this example embodiment may be associated with a guest application on the guest system. The program instructions of this example embodiment may additionally comprise program instructions, which when performed by an apparatus, are configured to cause the apparatus to cause the guest application to be provided with access to directly control the device as if the device were present on the guest system without implementing a driver specific to the device on the guest system. Control of the device in this example embodiment may be concurrently shared between the guest application and the host system.

In another example embodiment, an apparatus is provided that may comprise means for providing a devirtualization server driver on a host system. The apparatus of this example embodiment may further comprise means for receiving, at the devirtualization server driver, a request from a devirtualization client driver on a guest system for access to a physical device implemented on the host system. The request of this example embodiment may be associated with a guest application on the guest system. The apparatus of this example embodiment may additionally comprise means for causing the guest application to be provided with access to directly control the device as if the device were present on the guest system without implementing a driver specific to the device on the guest system. Control of the device in this example embodiment may be concurrently shared between the guest application and the host system.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus for providing application level device transparency via device devirtualization according to some example embodiments;

FIG. 2 is a schematic block diagram of a mobile terminal according to some example embodiments;

FIG. 3 illustrates an example system layer diagram according to an example implementation of a system for providing application level device transparency via device devirtualization according to some example embodiments;

FIG. 4 illustrates an example system layer diagram according to an example implementation of a system for providing application level device transparency via device devirtualization in an intrinsic system according to some example embodiments;

FIG. 5 illustrates an example system layer diagram according to an example implementation of a system for providing application level device transparency via device devirtualization in an extrinsic system according to some example embodiments;

FIG. 6 illustrates an example system layer diagram according to an example implementation of a system for providing application level device transparency via device devirtualization for a graphics processing device according to some example embodiments;

FIG. 7 illustrates an example system layer diagram according to an example implementation of a system for providing a shared memory space for use in device devirtualization according to some example embodiments; and

FIG. 8 illustrates a flowchart according to an example method for providing application level device transparency via device devirtualization according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

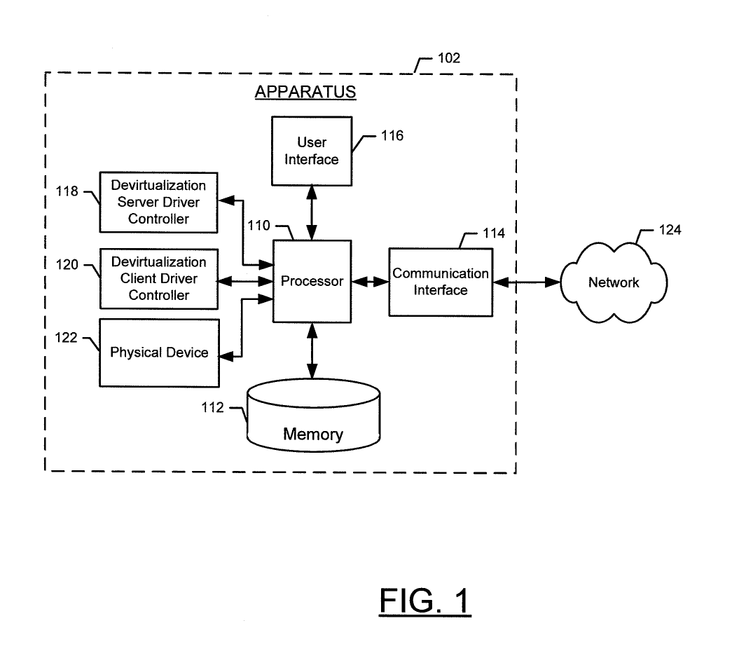

FIG. 1 illustrates a block diagram of an apparatus 102 for providing application level device transparency via device devirtualization according to some example embodiments. It will be appreciated that the apparatus 102 is provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of an apparatus for providing application level device transparency via device devirtualization, other configurations may also be used to implement embodiments of the present invention.

The apparatus 102 may be embodied as one or more servers, a server cluster, a cloud computing infrastructure, one or more desktop computers, one or more laptop computers, one or more network nodes, multiple computing devices in communication with each other, a mobile terminal, mobile computer, mobile phone, mobile communication device, game device, digital camera/camcorder, audio/video player, television device, digital video recorder, positioning device, game controller, television controller, electronic device controller, chipset, a computing device comprising a chipset, any combination thereof, and/or the like. In this regard, the apparatus 102 may comprise any computing device or plurality of computing devices that may be configured to provide a host system and/or a guest system that may support device devirtualization in accordance with one or more example embodiments.

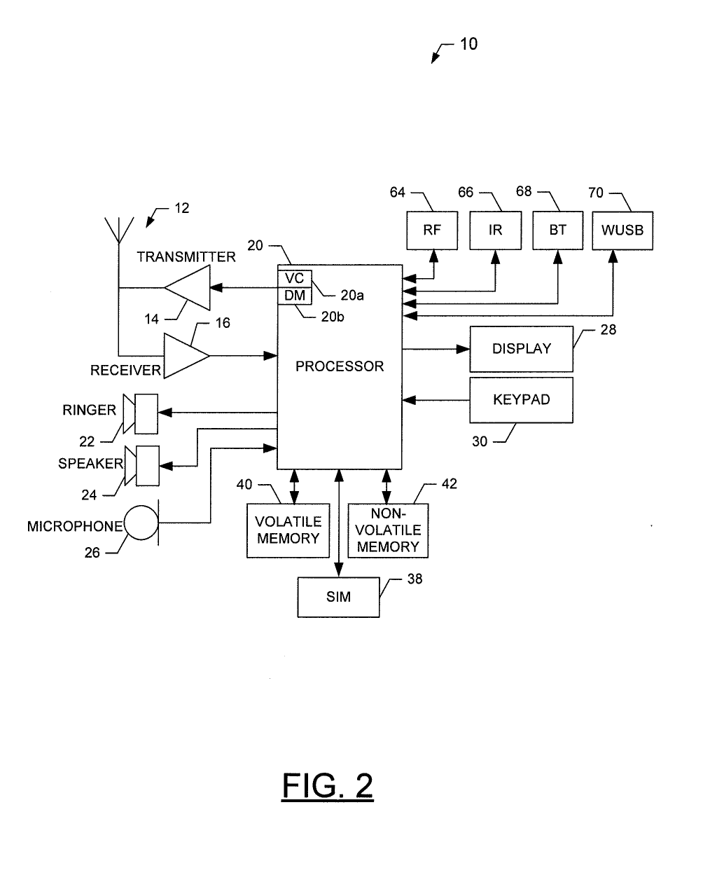

In some example embodiments, the apparatus 102 may be embodied as a mobile computing device, such as the mobile terminal illustrated in FIG. 2. In this regard, FIG. 2 illustrates a block diagram of a mobile terminal 10 representative of some example embodiments of an apparatus 102. It should be understood, however, that the mobile terminal 10 illustrated and hereinafter described is merely illustrative of one type of apparatus 102 that may implement and/or benefit from various embodiments of the invention and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), future communication, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 4G wireless communication protocols such as Long Term Evolution (LTE) or Evolved Universal Terrestrial Radio Access Network (E-UTRAN) and/or the like. Additionally, for example, the mobile terminal may be capable of operating in accordance with wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. One or more of the volatile memory 40 or non-volatile memory 42 may be embodied as a tangible, non-transitory memory. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in some example embodiments, the apparatus 102 includes various means for performing the various functions herein described. These means may comprise one or more of a processor 110, memory 112, communication interface 114, user interface 116, devirtualization server driver controller 118, devirtualization client driver controller 120, or physical device 122. The means of the apparatus 102 as described herein may be embodied as, for example, circuitry, hardware elements (e.g., a suitably programmed processor, combinational logic circuit, and/or the like), a computer program product comprising a computer-readable medium (e.g. memory 112) storing computer-readable program instructions (e.g., software or firmware) that are executable by a suitably configured processing device (e.g., the processor 110), or some combination thereof.

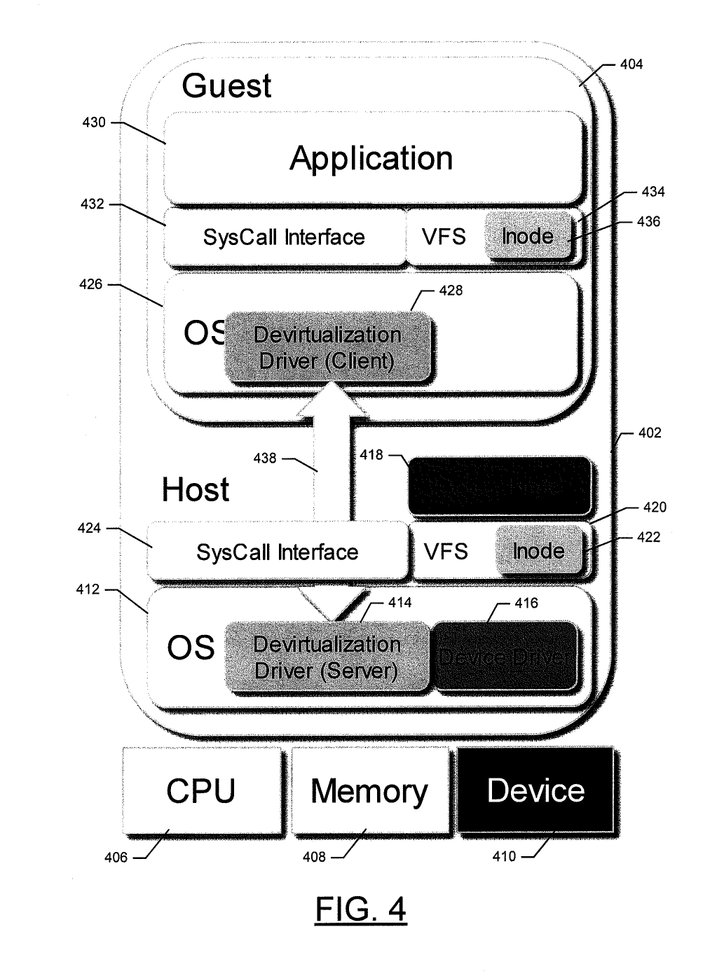

It will be appreciated that the means illustrated in FIG. 1 are illustrated by way of example. Accordingly, it will be appreciated that in some example embodiments, one or more of the means illustrated in FIG. 1 may be eliminated. Further, in some example embodiments, the apparatus 102 may comprise one or more means in addition to or in lieu of the means illustrated in FIG. 1. In some example embodiments, such as, for example, in embodiments supporting extrinsic devirtualization as described herein below and illustrated in FIG. 4, the means of the apparatus 102 may be distributed among and/or split between multiple computing devices. For example, the devirtualization server driver controller 118 may be implemented on a first computing device and the devirtualization client driver controller 120 may be implemented on a second computing device that may be in communication with the first computing device. Accordingly, it will be appreciated that while the apparatus 102 is illustrated as a single apparatus, the apparatus 102 may comprise a plurality of computing devices that may be in operative communication with each other to provide device devirtualization in accordance with one or more example embodiments. In some example embodiments in which the apparatus 102 comprises a plurality of computing devices, the plurality of computing devices may, for example, be in operative communication with each other via the network 124.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, devirtualization server driver controller 118, devirtualization client driver controller 120, and/or physical device 122 may be at least partially embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some example embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to one or more example embodiments while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may, for example, be stored and/or used by the devirtualization server driver controller 118 and/or devirtualization client driver controller 120 during the course of performing their functionalities.

The communication interface 114 may be embodied as any device or means embodied in circuitry, hardware, a computer program product comprising a computer readable medium (e.g., the memory 112) storing computer readable program instructions that may be executed by a processing device (e.g., the processor 110), or a combination thereof that is configured to receive and/or transmit data from/to another computing device. In some example embodiments, the communication interface 114 may be at least partially embodied as or otherwise controlled by the processor 110. The communication interface 114 may accordingly be in communication with the processor 110, such as via a bus, in some example embodiments. The communication interface 114 may additionally be in communication with the memory 112, user interface 116, devirtualization server driver controller 118, devirtualization client driver controller 120, and/or physical device 122, such as via a bus(es).

The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. As an example, the communication interface 114 may be configured to receive and/or transmit data using any protocol that may be used for transmission of data over a network, such as the network 124, by which the apparatus 102 and one or more computing devices may be in communication. The network 124 may, for example, comprise one or more wireline networks, one or more wireless networks (e.g., a cellular network, wireless local area network, wireless wide area network, some combination thereof, or the like), some combination thereof, or the like, and in some example embodiments may comprise the internet. As another example, the communication interface 114 may be configured to support communication via a direct interface (e.g., a FireWire connection, Universal Serial Bus connection, Bluetooth connection, and/or the like), such as may be used to support communication between the apparatus 102 and another computing device and/or between multiple computing devices that may collectively comprise the apparatus 102 in some example embodiments.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some example embodiments, aspects of the user interface 116 may be more limited, or the user interface 116 may even be removed entirely. The user interface 116 may be in communication with the memory 112, communication interface 114, devirtualization server driver controller 118, devirtualization client driver controller 120, and/or physical device 122, such as via a bus(es).

The devirtualization server driver controller 118 may be embodied as various means, such as circuitry, hardware, a computer program product comprising a computer readable medium (e.g., the memory 112) storing computer readable program instructions that may be executed by a processing device (e.g., the processor 110), or some combination thereof and, in some embodiments, is embodied as or otherwise controlled by the processor 110. In embodiments wherein the devirtualization server driver controller 118 is embodied separately from the processor 110, the devirtualization server driver controller 118 may be in communication with the processor 110. The devirtualization server driver controller 118 may further be in communication with one or more of the memory 112, communication interface 114, user interface 116, devirtualization client driver controller 120, or physical device 122, such as via a bus. In some example embodiments, the devirtualization server driver controller 118 may be configured to provide a devirtualization server driver for supporting device devirtualization in accordance with one or more example embodiments. In this regard, the devirtualization server driver controller 118 may be configured to implement and/or control functionality of a devirtualization server driver, as described further herein below.

The devirtualization client driver controller 120 may be embodied as various means, such as circuitry, hardware, a computer program product comprising a computer readable medium (e.g., the memory 112) storing computer readable program instructions that may be executed by a processing device (e.g., the processor 110), or some combination thereof and, in some embodiments, is embodied as or otherwise controlled by the processor 110. In embodiments wherein the devirtualization client driver controller 120 is embodied separately from the processor 110, the devirtualization client driver controller 120 may be in communication with the processor 110. The devirtualization client driver controller 120 may further be in communication with one or more of the memory 112, communication interface 114, user interface 116, devirtualization server driver controller 118, or physical device 122, such as via a bus(es). In some example embodiments, the devirtualization client driver controller 120 may be configured to provide a devirtualization client driver for supporting device devirtualization in accordance with one or more example embodiments. In this regard, the devirtualization client driver controller 120 may be configured to implement and/or control functionality of a devirtualization client driver, as described further herein below.

The apparatus 102 may additionally comprise one or more physical devices 122. A physical device 122 may comprise any physical hardware resource which may be implemented on the apparatus 102. In this regard, a physical device 122 may comprise any physical device that may be implemented on a host system. By way of example, a physical device 122 may comprise a physical graphics controller, such as a physical graphics card, physical graphics device, or the like. As another example, a physical device 122 may comprise a physical network controller, such as a physical network interface card, a physical network device, or the like. As still a further example, a physical device 122 may comprise a physical storage controller. It will be appreciated, however, that a physical graphics controller, physical network controller, and physical storage controller are provided only by way of example of some embodiments of a physical device 122, and not by way of limitation.

In some example embodiments, a guest application that may run on a system may leverage a device(s) (e.g., a physical device 122) implemented on a host system. The host system may comprise a host operating system in some example embodiment. One or more host applications may be run on the host operating system, and may use the device(s) implemented on the host system. In some example embodiments (e.g., intrinsic embodiments), the guest system may comprise a virtualized system that may run on top of the host system, such as on a hypervisor that may be implemented on top of the host system, on a single physical computing device. Alternatively, in some example embodiments (e.g., extrinsic embodiments), the host system and guest system may be implemented on separate physical computing devices, which may be connected to each other such that the guest system may leverage a device(s) implemented on the host system. A guest operating system may be run on the guest system.

In accordance with some example embodiments, applications on a guest system may transparently and directly control devices (e.g., physical devices 122) on the host system without the guest operating system having to know anything about those devices. In this regard, in some example embodiments, a hardware state does not have to be altered on the guest system and the guest operating system does not have to have any knowledge of the device(s) on the host system that may be introduced for control by a guest application. Accordingly, in some example embodiments, device drivers for a device (e.g., a physical device 122) implemented on the host system for which a guest application is provided with access to control the device do not have to be loaded by the guest operating system. In such example embodiments, control of a device on a host system may be concurrently shared between a guest application and one or more applications on the host system. In some example embodiments the guest operating system may be configured (e.g., under the control of the devirtualization client driver controller 120) to support device devirtualization by treating host hardware devices (e.g., physical devices 122) as anonymous device files on the guest system. The guest operating system may be further configured (e.g., under the control of the devirtualization client driver controller 120) to provide anonymous guest file descriptors for devices implemented on the host system. In some example embodiments, the anonymous guest file descriptors may, for example, comprise inodes. The anonymous guest file descriptors may include one or more file system operations (e.g., virtual file system methods) that are overloaded with semantics to remote file operations onto the actual device driver(s) on the host system, which may perform the device operations on the actual hardware device(s). In this regard, in some example embodiments, all devices on the host system (e.g., physical devices 122) may be treated in the same way (as anonymous files), and requests from the guest applications may be blindly forwarded to the device drivers on the host system under the control of the devirtualization client driver controller 120.

Having generally described providing application level device transparency via device devirtualization in accordance with some example embodiments, more particular functionality and structure that may be implemented by the apparatus 102 to support device virtualization in accordance with various example embodiments will now be described. As previously discussed, a devirtualization client driver may be provided by the devirtualization client driver controller 120 in some example embodiments. The devirtualization client driver may, for example be integrated into a kernel of a guest operating system implemented that may be implemented on the guest system.

A guest application on the guest system may make a call to a device (e.g., try to open a device file). If the device (e.g., the device file) is not present on the guest system, the devirtualization client driver may be configured to send a request for access to the physical device to the devirtualization server driver. As previously discussed, the devirtualization server driver may be provided by the devirtualization server driver controller 118. The devirtualization server driver may, for example, be integrated into a kernel of a host operating system that may be implemented on the host system. The request may, for example, comprise a hypercall form the devirtualization client driver to the devirtualization server driver. As another example, the request may comprise a TCP/IP (Transmission Control Protocol/Internet Protocol) request that may be sent from the devirtualization client driver to the devirtualization server driver. In this regard, kernel sockets may be used to support TCP/IP streams between the devirtualization client driver and the devirtualization server driver in some example embodiments.

The devirtualization server driver may receive the request sent by the devirtualization client driver. In response to the request, the devirtualization server driver may be configured to cause the guest application to be provided with access to directly control the device as if the device were present on the guest system without implementation of a driver specific to the device being implemented on the guest system. Control of the device may concurrently be shared between the guest application and the host system.

In some example embodiments, the devirtualization server driver may be configured to cause the guest application to be provided with access to directly control the device by placing a call to the device using one or more parameters included in the request received from the devirtualization client driver and, in an instance in which the call to the device is successful, sending a message to the devirtualization client driver to inform the devirtualization client driver that the request for access to the physical device was successful. The message to the devirtualization client driver may, for example, comprise a hypercall, TCP/IP message, and/or the like.

The devirtualization client driver may receive the message from the devirtualization server driver indicating that the request for access to the physical device was successful. In response to receipt of the message from the devirtualization server driver, the devirtualization client driver may create and return an anonymous file descriptor to the guest application. The anonymous file descriptor may, for example, comprise an inode. The anonymous file descriptor may include one or more overloaded virtual file system operations to remote the one or more file operations to the devirtualization server driver such that future calls to the device by the guest application may be peered via the anonymous file descriptor to the devirtualization server driver to enable the guest application to directly control the device as if the device were present on the guest system. In this regard, the devirtualization server driver may receive future calls to the device by the guest application via the anonymous file descriptor, and may place the call to the driver(s) for the device on the host system.

In some example embodiments, device devirtualization may be provided via a peer-to-peer protocol for device remoting in a virtualized environment. The protocol may be device-agnostic and operating system-agnostic, such that a single device devirtualization session can include clients and server having different platform and operating system architectures.

In some example embodiments, device devirtualization may be provided via a pair of kernel modules, including a devirtualization server driver (dvserver), which may be controlled by the devirtualization server driver controller 118, and devirtualization client driver (dvclient), which may be controlled by the devirtualization client driver controller 120. A machine with dvserver module loaded may behave as the server (e.g., host) for device remoting, and a machine (e.g., physical machine or virtual machine) with dvclient module loaded may behave as the client (e.g., guest). In some such example embodiments, the runtime arguments to the dvclient module may indicate which Internet protocol (IP) address(es) and port(s) to use to connect to the dvserver. In some implementations, a machine can be a devirtualization server and devirtualization client at the same time, such as for sharing/consuming different devices.

In some example embodiments, when a guest application on the guest system (e.g., a virtual machine) tries to open a device file, if the device (e.g., a physical device 122) is not present on the local guest system, the guest operating system may be configured to invoke the dvclient Application Programming Interface(s) (APIs) to request the dvserver to open the device, if present on the host system. If the dvserver is able to successfully open the device, the dvserver may send a success message intimating this success status to the dvclient. The dvclient may return an anonymous file descriptor, such as an inode or the like, to the guest application in response to the success message. The anonymous file descriptor's virtual file system operations may be overloaded to remote its file operations to the dvserver.

A variety of file operations that may be performed attendant to calls to a device may be remoted from the guest system to dvserver. Bay way of example, the file operations that may be remoted may include file operations, such as open, read, write, seek, flush, close, and/or the like. As a further example, file operations that may be remoted may include file descriptor properties, such as “poll” to determine if a file descriptor is read for read/write, “mmap” to direct map device memory into user address space, “ioctl” for private interfaces between device drivers and applications, and/or the like. As still a further example, operations that may be remoted may include virtual memory operations, such as operations to open and close virtual memory ranges (e.g., memory ranges that may be created by mmap), fault operations requested by a guest application for a page fault handler to map physical device memory into virtual memory, and/or the like.

When a guest application performs a file operation that is remoted, the anonymous file descriptor may redirect those operations to the appropriate dvclient entry points. The dvclient may forward the request to the dvserver to perform the same file operations with the specified arguments. In the case of intrinsic virtualization wherein the guest system may be run on top of the host system on a common computing device(s), such as in the case of a guest system running on a hypervisor, the remoting (forwarding) may happen via a hypercall from the dvclient to the dvserver. In the case of extrinsic virtualization wherein the guest system may be implemented on a first computing device and the host system may be implemented on a second computing device, the remoting (forwarding) may involve a network handshake between the dvclient and the dvserver. The dvserver may receive the request to perform a file operation, and in response to the request, may identify the server-side file descriptor for the guest application, perform the requested file operation, and return the results to the dvclient. In some instances, a file operation may result in the guest application data being directly read or modified by the dvserver and/or host operating system kernel, such as in the case of Linux copy_from_user( ) and copy_to_user( ) primitives that may be invoked by the host system device drivers.

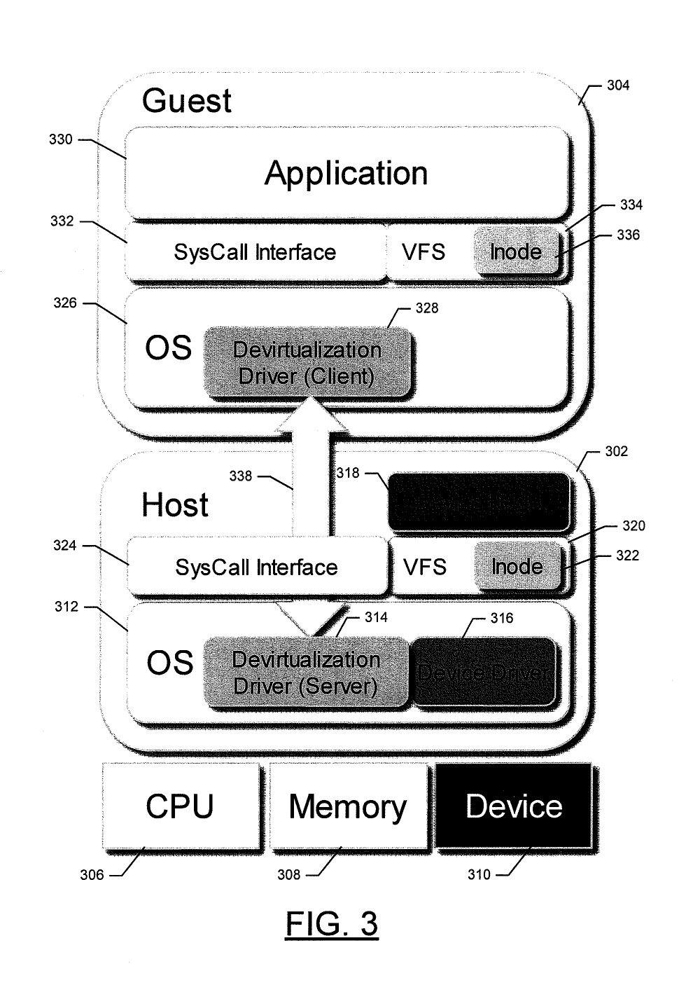

FIG. 3 illustrates an example system layer diagram according to an example implementation of a system for providing application level device transparency via device devirtualization according to some example embodiments. It will be appreciated that while the illustration of FIG. 3 illustrates an example system layer diagram in accordance with Unix/Linux device abstractions, embodiments disclosed herein may be similarly implemented on other operating systems, such as various versions of Microsoft Windows® and/or the like. As illustrated, the system of FIG. 3 may include a host system 302 and a guest system 304. The host system may be implemented directly on a hardware level, which may, for example, include a processor, such as a central processing unit (CPU), 306, memory 308, and a physical device 310. The physical device 310 may, for example, comprise an embodiment of a physical device 122. The host system may include a host operating system (OS) 312. A devirtualization server driver 314 may be integrated into the host operating system 312. The devirtualization server driver 314 may, for example, operate under the control of a devirtualization server driver controller 118 that may be associated with the host system 302. A device driver 316 may also be implemented on the host operating system 312. The device driver 316 may comprise a driver for the physical device 310. The host system 302 may also include a device node 318 that may be used by applications that may be implemented on the host system 302 to facilitate calls to access the physical device 310. The host system 302 may additionally include a virtual file system (VFS) 320, which may include an mode 322 that may be used to springboard a call to access the physical device 310 to an appropriate handler of the device driver 316. The host system 302 may also include a system call (SysCall) interface 324.

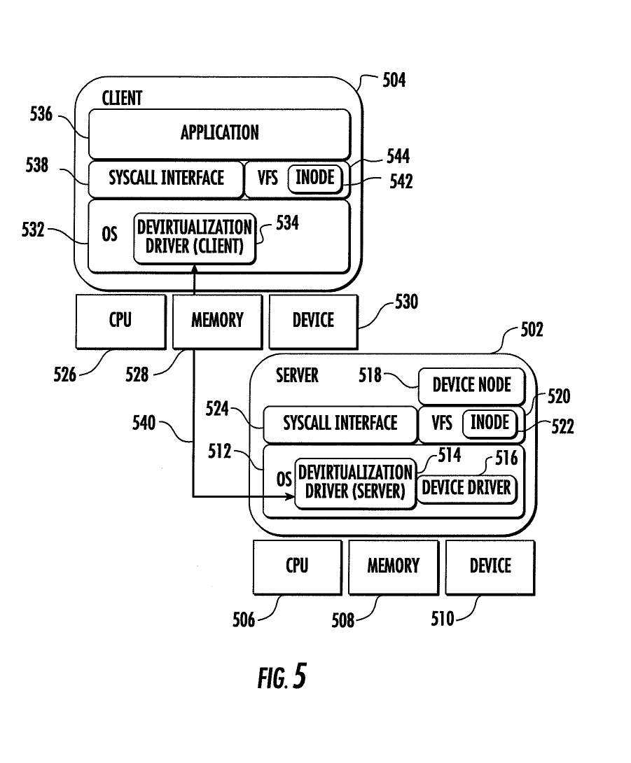

In intrinsic embodiments, such as that illustrated in FIG. 4, the guest system 304 may comprise a virtualized system that may run on top of the host system 302, such as on a hypervisor. Alternatively, in extrinsic embodiments, such as that illustrated in FIG. 5, the guest system 304 may be implemented on a separate physical computing device from a physical computing device on which the host system 302 may be implemented.

The guest system 304 may include a guest operating system 326. A devirtualization client driver 328 may be integrated into the guest operating system 326. The devirtualization client driver 328 may, for example, operate under the control of a devirtualization client driver controller 120 that may be associated with the guest system 304.

A guest application 330 may be run on the guest operating system 326 of the guest system 304. A system call (SysCall) interface 332 may be used to facilitate system calls by the guest application 330, such as calls to the guest operating system 326. The guest application 330 may make a system call to access a device (e.g., the physical device 310) that may not be implemented on the guest system 304. The devirtualization client driver 328 may be configured to intercept and/or receive a system call by the guest application 330 to a device that is not implemented on the guest system 304. The devirtualization client driver 328 may be configured to send a request for access to the device to the devirtualization server driver 314 via the communication path 338. In intrinsic embodiments, the communication path 338 may, for example, comprise a path by which the devirtualization client driver 328 and devirtualization server driver 314 may exchange messages, such as via hypercalls, TCP/IP communication, and/or the like. In extrinsic embodiments, the communication path 338 may comprise any connection between a first physical computing device on which the guest system 304 may be implemented and a second physical computing device on which the host system 302 may be implemented, such as a physical link (e.g., a USB connection, FireWire connection, or the like), a proximity-based over-the-air link (e.g., a Bluetooth connection or the like), a connection over a network (e.g., the network 124), and/or the like.

The devirtualization server driver 314 may be configured to receive the request from the devirtualization client driver 328 and may place a call to the device 310. In some example embodiments, the devirtualization server driver 314 may not have actual knowledge of the device 310 or the device driver 316 for the device 310, and may make the call using one or more parameters that may be included in the request received from the devirtualization client driver 328. If the call is successful, the devirtualization server driver 314 may be configured to send a message to the devirtualization client driver 328 via the communication path 338 to inform the devirtualization client driver 328 that the request was successful.

The devirtualization client driver 328 may be configured to receive the confirmation that the request was successful. The devirtualization client driver 328 may be configured to create an anonymous file descriptor, such as the inode 336, in the virtual file system (VFS) 334 on the guest system 304. The inode 336 may include one or more overloaded virtual file system operations to remote the file operations to the devirtualization server driver 314 such that future calls to the device 310 by the guest application 330 may be peered via the inode 336 to the devirtualization server driver 314 to enable the guest application 330 to directly control the device 310 as if the device 310 were present on the guest system 304. The devirtualization client driver 328 may be further configured to return the inode 336 to the guest application 330 in response to the original device call by the guest application 330, thereby allowing the call to succeed. Accordingly, operations to enable the guest application 330 to control the device 310 may be transparent to the guest application 330 such that the guest application 330 may believe that the device 310 is present on the guest system 304, and the guest application 330 may not need to be modified to utilize device devirtualization in accordance with various example embodiments. Future calls to the device 310 by the guest application 330 may accordingly be peered via the inode 336 to the devirtualization server driver 314.

FIG. 4 illustrates an example system layer diagram according to an example implementation of a system for providing application level device transparency via device devirtualization in an intrinsic system according to some example embodiments. It will be appreciated that while the illustration of FIG. 4 illustrates an example system layer diagram in accordance with Unix/Linux device abstractions, embodiments disclosed herein may be similarly implemented on other operating systems, such as various versions of Microsoft Windows® and/or the like. As illustrated, the system of FIG. 4 may include a host system 402. The host system may be implemented directly on a hardware level, which may, for example, include a processor, such as a central processing unit (CPU), 406, memory 408, and a physical device 410. The physical device 410 may, for example, comprise an embodiment of a physical device 122. The host system may include a host operating system (OS) 412. A devirtualization server driver 414 may be integrated into the host operating system 412. The devirtualization server driver 414 may, for example, operate under the control of a devirtualization server driver controller 118 that may be associated with the host system 402. A device driver 416 may also be implemented on the host operating system 412. The device driver 416 may comprise a driver for the physical device 410. The host system 402 may also include a device node 418 that may be used by applications that may be implemented on the host system 402 to facilitate calls to access the physical device 410. The host system 402 may additionally include a virtual file system (VFS) 420, which may include an inode 422 that may be used to springboard a call to access the physical device 410 to an appropriate handler of the device driver 416. The host system 402 may also include a system call (SysCall) interface 424.

The guest system 404 may comprise a virtualized system that may run on top of the host system 402, such as on a hypervisor. Accordingly, the host system 402 and guest system 404 may be implemented on the same physical computing device. The guest system 404 may include a guest operating system 426. A devirtualization client driver 428 may be integrated into the guest operating system 426. The devirtualization client driver 428 may, for example, operate under the control of a devirtualization client driver controller 120 that may be associated with the guest system 404.

A guest application 430 may be run on the guest operating system 426 of the guest system 404. A system call (SysCall) interface 432 may be used to facilitate system calls by the guest application 430, such as calls to the guest operating system 426. The guest application 430 may make a system call to access a device (e.g., the physical device 410) that may not be implemented on the guest system 404. The devirtualization client driver 428 may be configured to intercept and/or receive a system call by the guest application 430 to a device that is not implemented on the guest system 404. The devirtualization client driver 428 may be configured to send a request for access to the device to the devirtualization server driver 414 via the communication path 438. The communication path 438 may, for example, comprise a path by which the devirtualization client driver 428 and devirtualization server driver 414 may exchange messages, such as via hypercalls, TCP/IP communication, and/or the like.

The devirtualization server driver 414 may be configured to receive the request from the devirtualization client driver 428 and may place a call to the device 410. In some example embodiments, the devirtualization server driver 414 may not have actual knowledge of the device 410 or the device driver 416 for the device 410, and may make the call using one or more parameters that may be included in the request received from the devirtualization client driver 428. If the call is successful, the devirtualization server driver 414 may be configured to send a message to the devirtualization client driver 428 via the communication path 438 to inform the devirtualization client driver 428 that the request was successful.

The devirtualization client driver 428 may be configured to receive the confirmation that the request was successful. The devirtualization client driver 428 may be configured to create an anonymous file descriptor, such as the inode 436, in the virtual file system (VFS) 434 on the guest system 404. The inode 436 may include one or more overloaded virtual file system operations to remote the file operations to the devirtualization server driver 414 such that future calls to the device 410 by the guest application 430 may be peered via the inode 436 to the devirtualization server driver 414 to enable the guest application 430 to directly control the device 410 as if the device 410 were present on the guest system 404. The devirtualization client driver 428 may be further configured to return the inode 436 to the guest application 430 in response to the original device call by the guest application 330, thereby allowing the call to succeed. Accordingly, operations to enable the guest application 430 to control the device 410 may be transparent to the guest application 430 such that the guest application 430 may believe that the device 410 is present on the guest system 404, and the guest application 430 may not need to be modified to utilize device devirtualization in accordance with various example embodiments. Future calls to the device 410 by the guest application 430 may accordingly be peered via the inode 436 to the devirtualization server driver 414.

FIG. 5 illustrates an example system layer diagram according to an example implementation of a system for providing application level device transparency via device devirtualization in an extrinsic system according to some example embodiments. It will be appreciated that while the illustration of FIG. 5 illustrates an example system layer diagram in accordance with Unix/Linux device abstractions, embodiments disclosed herein may be similarly implemented on other operating systems, such as various versions of Microsoft Windows® and/or the like. As illustrated, the system of FIG. 5 may include a server 502 and a client 504. The server 502 may comprise a host system, and may be implemented on a first physical computing device. The client 504 may comprise a guest system, and may be implemented on a second physical computing device that may be in communication with the computing device on which the server 502 is implemented.

The server 502 may, for example, include a processor, such as a central processing unit (CPU), 506, memory 508, and a physical device 510. The physical device 510 may, for example, comprise an embodiment of a physical device 122. The server 502 may include an operating system (OS) 512 (e.g., a host operating system). A devirtualization server driver 514 may be integrated into the operating system 512. The devirtualization server driver 514 may, for example, operate under the control of a devirtualization server driver controller 118 that may be associated with the server 502. A device driver 516 may also be implemented on the operating system 512. The device driver 516 may comprise a driver for the physical device 510. The server 502 may also include a device node 518 that may be used by applications that may be implemented on the server 502 to facilitate calls to access the physical device 510. The server 502 may additionally include a virtual file system (VFS) 520, which may include an inode 522 that may be used to springboard a call to access the physical device 510 to an appropriate handler of the device driver 516. The server 502 may also include a system call (SysCall) interface 524.

The client 504 may, for example, include a processor, such as a central processing unit (CPU), 526, memory 528, and a physical device 530. The client 504 may include an operating system 532 (e.g., a guest operating system). A devirtualization client driver 534 may be integrated into the operating system 532. The devirtualization client driver 534 may, for example, operate under the control of a devirtualization client driver controller 120 that may be associated with the client 504.

A guest application 536 may be run on the operating system 532. A system call (SysCall) interface 538 may be used to facilitate system calls by the guest application 536, such as calls to the operating system 532. The guest application 536 may make a system call to access a device. If the call is to access a device present on the client 504, such as the device 530, the call may be handled in accordance with general procedures of the operating system 532. If, however, the call is to access a device, such as the physical device 510, that is not implemented on the guest system 304, the devirtualization client driver 534 may be configured to intercept and/or receive the system call by the guest application 536. The devirtualization client driver 534 may be configured to send a request for access to the device to the devirtualization server driver 514 via the communication path 540. The communication path 540 may comprise any connection between the server 502 and the client 504, such as a physical link (e.g., a USB connection, FireWire connection, or the like), a proximity-based over-the-air link (e.g., a Bluetooth connection or the like), a connection over a network (e.g., the network 124), and/or the like.

The devirtualization server driver 514 may be configured to receive the request from the devirtualization client driver 534 and may place a call to the device 510. In some example embodiments, the devirtualization server driver 514 may not have actual knowledge of the device 510 or the device driver 516 for the device 510, and may make the call using one or more parameters that may be included in the request received from the devirtualization client driver 534. If the call is successful, the devirtualization server driver 514 may be configured to send a message to the devirtualization client driver 534 via the communication path 540 to inform the devirtualization client driver 534 that the request was successful.

The devirtualization client driver 534 may be configured to receive the confirmation that the request was successful. The devirtualization client driver 534 may be configured to create an anonymous file descriptor, such as the inode 542, in the virtual file system (VFS) 544 on the client 504. The inode 542 may include one or more overloaded virtual file system operations to remote the file operations to the devirtualization server driver 514 such that future calls to the device 510 by the guest application 536 may be peered via the inode 542 to the devirtualization server driver 514 to enable the guest application 536 to directly control the device 510 as if the device 510 were present on the client 504. The devirtualization client driver 534 may be further configured to return the inode 542 to the guest application 536 in response to the original device call by the guest application 536, thereby allowing the call to succeed. Accordingly, operations to enable the guest application 536 to control the device 510 may be transparent to the guest application 536 such that the guest application 536 may believe that the device 510 is present on the client 504, and the guest application 536 may not need to be modified to utilize device devirtualization in accordance with various example embodiments. Future calls to the device 510 by the guest application 536 may accordingly be peered via the inode 542 to the devirtualization server driver 514.

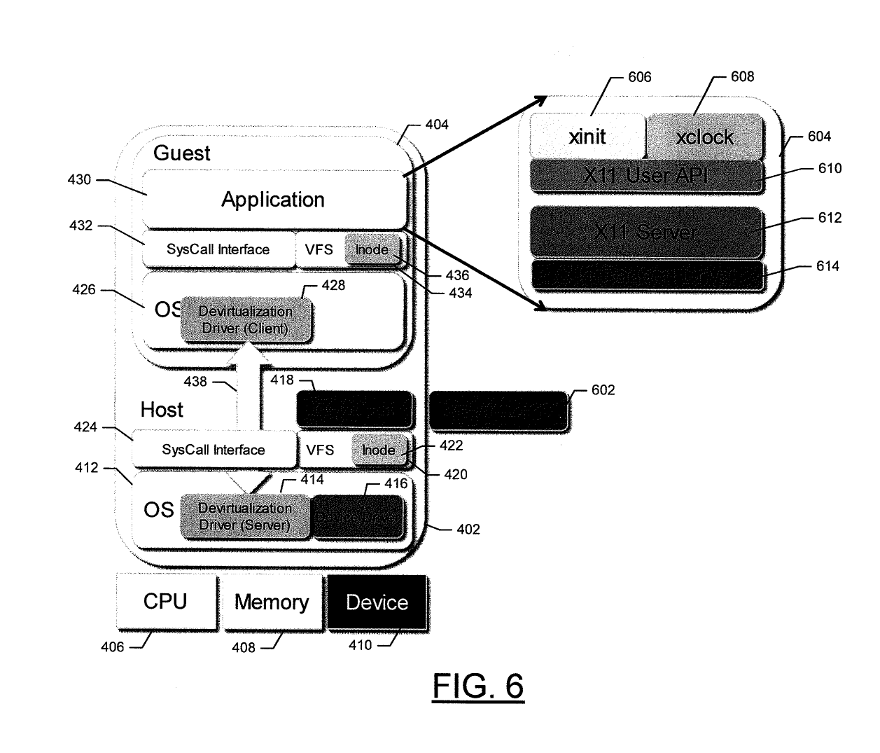

FIG. 6 illustrates an example system layer diagram according to an example implementation of a system for providing application level device transparency via device devirtualization for a graphics processing device according to some example embodiments. It will be appreciated that while the illustration of FIG. 6 illustrates an example system layer diagram in accordance with Unix/Linux device abstractions, embodiments disclosed herein may be similarly implemented on other operating systems, such as various versions of Microsoft Windows® and/or the like. In this regard, FIG. 6 illustrates an example implementation of the system of FIG. 4 in which the physical device 410 may comprise a graphics processing device, such as, for example, an ATI Radeon Graphics Processing Unit (GPU). In the example of FIG. 6, the device node 418 may, for example, have the file name 602 /dev/dri/card0. Further, in the example of FIG. 6, the guest application 430 may have the example Linux X11 application stack 604. The application stack 604 may include X11 applications (e.g., xinit 606, xclock 608, and/or the like), X11 user APIs 610, X11 server 612, and an X1 device driver 614 for the ATI Radeon GPU. In the example of FIG. 6, the application stack 604 may be able to exploit hardware acceleration for graphics processing that may be offered by the physical device 410 on the host system 402 due to devirtualization of the device 410. In this regard, the application stack 604 may be enabled by way of the devirtualization client driver 428 and devirtualization server driver 414 to bridge the application 430's intent to operate on the device 410 through the devirtualization server driver 414 to the device driver 416 without necessitating any modification of the application 430 or application stack 604. Accordingly, the application 430 may operate on the device 410 as if the device 410 were implemented on the guest system 404.

In some example embodiments, the host system (e.g., the host system 302, host system 402, and/or the like) may be configured to maintain a merged address space for the host operating system (e.g., the host operating system 312 host operating system 412, and/or the like) to and a guest user address space that may be used by a guest application (e.g., the guest application 330, guest application 430, and/or the like). In some such example embodiments, the devirtualization server driver controller 118 may be configured to control maintenance of the merged address space. The merged address space may be used for any memory operations that may be performed in response to a call from the guest application to control a physical device 122 (e.g., a physical device 310, physical device 410, and/or the like). Usage of a merged address space for the host operating system and the user address space for a guest application may ensure that remote file operations may be performed on the host system with the same arguments (e.g., parameters) as those passed from the guest application to the client system, which may be used in a peered request from the guest system to the devirtualization server driver.

As an example, when copying data from/to a guest application user space, pointer arguments passed for file operations may refer to the calling guest application's address space. Thus when the pointers are dereferenced, it must be ensured that the correct page tables and segment descriptors are used to reach the correct memory content in the guest application's address space. If the guest system is not implemented as a virtualized system running on the host system, a two-step memory dereference process wherein the host system may pass a request to the guest system to dereference the memory pointer in the file operation, and the guest system reads/writes the user address space and intimates the host system of the results may be used. However, in intrinsic implementations, such as implementations in which the guest system is implemented as a virtualized system running on the host system, such as a virtualized system running on a hypervisor on the host system, a merged address space for the host operating system and the user address space for a guest application may be used to reduce the two-step dereference process into a single memory operation on the host system by ensuring that through use of a merged address space, the user address space on the host system also references the same physical memory pages as the user address space on the client. In some example implementations, the merged address space may be supported by fixing the page mappings in the shadow page table, extended page table (EPT), and/or the like, such as in accordance with a memory management unit (MMU) architecture of a hypervisor that may be used for running the guest system.

As another example, a merged address space may be used to support n mmap of device memory onto the guest application user address space. In this regard, physical device memory may reside on the host system and the mmpaped virtual memory segment may be mapped on the guest system user address space. When a merged address space is used, the references to these memory ranges from the guest system may coherently reflect in the host system as well. In this regard, when a guest application writes to a mmaped memory segment, the write may automatically reflect onto the device memory on the host system. When a page fault is forwarded to the host system, the device driver on the host system may handle page faults and map device memory pages (e.g., physical memory pages) onto the virtual address requested by the guest application on the host system user address space (e.g., the merged address space). In this regard, if the same physical memory pages are mapped into the guest application virtual address space in the guest system, then both the guest system and the host system may read/write the same page, thereby providing coherency.

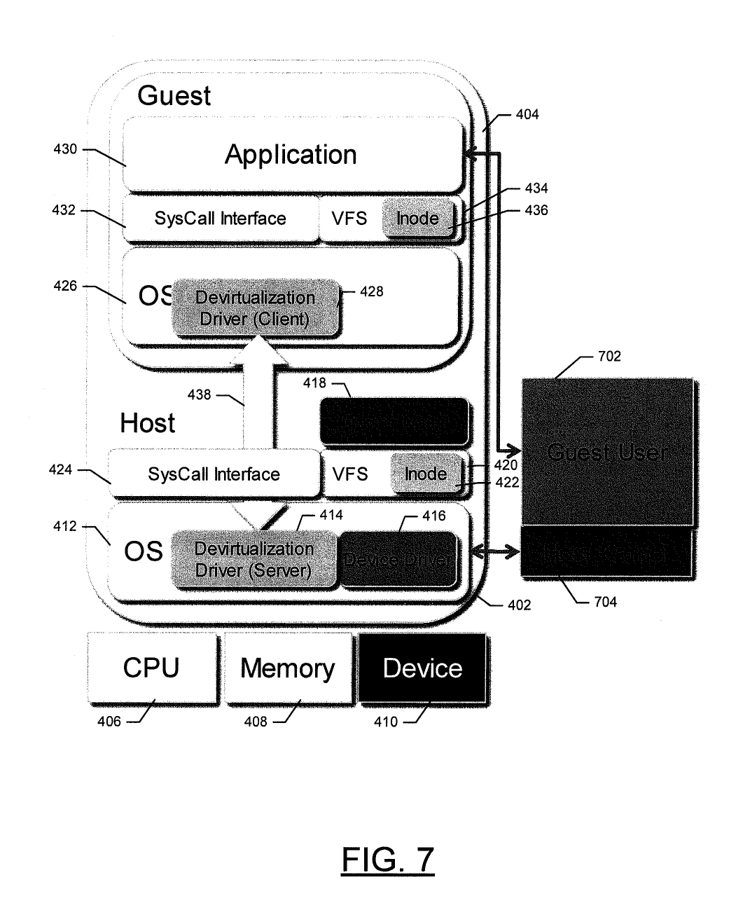

FIG. 7 illustrates an example system layer diagram according to an example implementation of a system for providing a shared memory space for use in device devirtualization according to some example embodiments. More particularly, FIG. 7 illustrates an example implementation of an intrinsic system, such as the system of FIG. 4, in the guest user address space 702 for the guest application 430 and the host kernel address space 704 for the host operating system 412 may be maintained as a merged address space. Accordingly, the guest user address space 702 may be directly accessible by the host system 402, such as by the device driver 416. The merged address space may, for example, enable copy_{from|to}_user calls by the guest application 430 to be performed by the host system 402 such that data may be seamlessly transferred from/to the guest user address space 702. As another example, the merged address space may facilitate a mmap operation performed for a Memory-Mapped Input/Output (MMIO) operation of the device 410 to directly install a page into the guest user address space 702.

In view of the preceding description, it will be appreciated that in accordance with some example embodiments, no changes are required to be implemented in guest applications to support device devirtualization in accordance with various example embodiments. Accordingly, as long as guest applications know how to operate on physical devices as if they were present on the guest system, device devirtualization in accordance with some example embodiments may enable a guest application to transparently operate on a physical device implemented on the host system.

In some example embodiments, a guest application may be enabled to operate on any physical device on a host system that may be controlled by a virtual file system of the host operating system, such that the physical device is treated as a file in the files system (for example, the console device may be the device file, /dev/console, and/or the like). In some example embodiments, devirtualization may be implemented as an abstraction over the host system's virtual file system so that the virtual file operations (e.g., open, close, mmap, etc.) for the guest system's file descriptors may be redirected to functions that may forward the device operation requests to the host system's device drivers.

In some example embodiments, physical devices controlled by user mode device drivers on the host system cannot be devirtualized in the guest system. In this regard, single applications on the host system which assume exclusive ownership of a device, and operate on them with user mode drivers, may prevent the device from being seen and operated upon by guest applications.

Some example embodiments provide application level control of physical devices on a host system by a guest application. Accordingly, guest applications may directly control hardware devices on the host. Further, in accordance with some example embodiments, the guest operating system does not have to know about the semantics of the host devices being operated on. No virtual/real device drivers for the device are needed on the guest system. The physical devices on the host system may appear to be local devices (e.g., devices on the guest system) to the guest application.

Some example embodiments may provide enhanced performance for a guest application. In this regard, some example embodiments enable a guest application to talk directly to hardware devices on the host system. Accordingly, some example embodiments may provide close to native performance for the guest applications. As an example, an X11 server in a guest operating system may control hardware acceleration features of an ATI/RADEON card that may be present on the host system of which only the host system may be aware. In some example embodiments, device devirtualization may provide close to native performance for the guest application without compromising concurrency of device usage by the host system.

Some example embodiments may provide a memory sharing architecture enabling a merged address space for a host operating system kernel and a guest user address space used by the guest application. Such example embodiments may provide for enhancement of operations to copy from/to guest application user address space and remote mmaps in implementations in which the guest system is running on a hypervisor on the host system.

Some example embodiments may provide transparent support for distributed/concurrent and atomic/interleaved operations. In accordance with some example embodiments, operations may be performed at the system call interface. A host system in accordance with some example embodiments may not see a guest application that tries to operate on host system devices any differently from applications on the host system. Accordingly, the host device drivers may be able to arbitrate requests for concurrent/atomic operations involving a guest application as it would among host applications. In some example embodiments, a device driver for a host system device may directly perceive the granularity of a guest application user request, and may atomically perform the operations if warranted by the device semantics.

Some example embodiments may provide for dynamic discovery of devices by a guest application. In this regard, when the guest application tries to open a device, if the device is not present on the guest, the request may be automatically forwarded to the host system (e.g., from the devirtualization client driver to the devirtualization host driver). This remoting may be automatically and transparently affected for any device on the host system.

Some example embodiments may support many-to-many connections (e.g., many guest systems connecting to may host systems). The guest systems in some such example embodiments may either maintain a directory of devices present on the host systems, or the guest systems may blindly broadcast to all host systems, when a device access is requested, entrusting the host systems to respond if they have the requested device, and they can permit the client to use it.

Some example embodiments support implementation across operating systems. In this regard, devirtualization may comprise a peer-to-peer protocol where guest systems and host systems may be heterogeneous, running on different platforms with different operating systems.

Various example embodiments may be used for a diverse array of applications. Devirtualization in accordance with some example embodiments may provide a more efficient way of graphics remoting than Virtual Network Computing (VNC), Remote Desktop Protocol (RDP), Virtual Desktop Infrastructure (VDI), Intel WiDi (Wireless Display, or WirelessHD), IP Cameras, or the like, since, as the graphics remoting may occur early on, in a pre-rendered form, in some example embodiments, the computation and network bandwidth required may be significantly less than in the other technologies where (possibly compressed) fully rendered screen images are transmitted between computers. In some example embodiments, devirtualization may be used to create interactive collaborative devices which may have the look and feel of Microsoft Surface™, where the host system (surface) may accept pre-rendered images from multiple guest systems, and render them onto vertical transparent tiles (one tile per source image). In some example embodiments, devirtualization may be used to facilitate efficient sharing of devices like sensors, cameras, biomedical monitors with other computers on the network. For example, cellphones with sensors may be used in trauma care. In this regard, emergency response teams may run applications on their central computers to control sensors on the cellphones through use of devirtualization to read vital statistics (heart rates, blood pressure, oxygen levels, electronic signals from heart, brain, etc.) of the trauma victim(s) to expedite diagnosis and treatment.

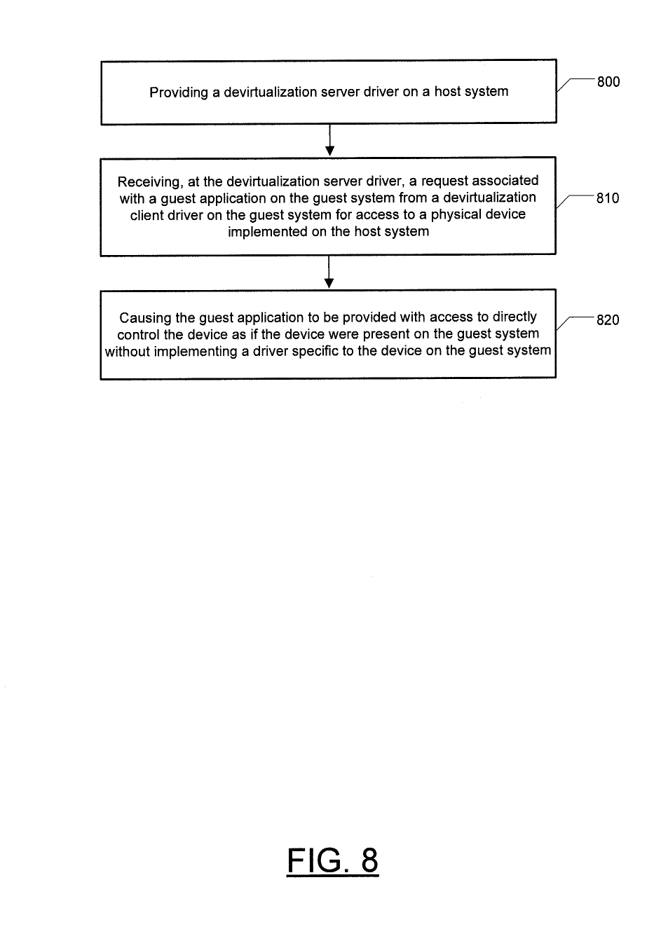

FIG. 8 illustrates a flowchart according to an example method for providing application level device transparency via device devirtualization according to some example embodiments. The operations illustrated in and described with respect to FIG. 8 may, for example, be performed by, with the assistance of, and/or under the control of one or more of the processor 110, memory 112, communication interface 114, user interface 116, devirtualization server driver controller 118, devirtualization client driver controller 120, or a physical device 122. Operation 800 may comprise providing, by a processor, a devirtualization server driver on a host system. The processor 110, memory 112, and/or devirtualization server driver controller 118 may, for example, provide means for performing operation 800. Operation 810 may comprise receiving, at the devirtualization server driver, a request from a devirtualization client driver on a guest system for access to a physical device implemented on the host system. The request may be associated with a guest application on the guest system. The processor 110, memory 112, communication interface 114, devirtualization server driver controller 118, and/or devirtualization client driver controller 120 may, for example, provide means for performing operation 810. Operation 820 may comprise causing the guest application to be provided with access to directly control the device as if the device were present on the guest system without implementing a driver specific to the device on the guest system. Control of the device may be concurrently shared between the guest application and the host system. The processor 110, memory 112, communication interface 114, devirtualization server driver controller 118, devirtualization client driver controller 120, and/or physical device 122 may, for example, provide means for performing operation 820.

FIG. 8 illustrates a flowchart of a system, method, and computer program product according to some example embodiments. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
providing, by a processor, a devirtualization server driver on a host system;
receiving, at the devirtualization server driver, a request from a devirtualization client driver on a guest system for access to a physical device implemented on the host system, the request being associated with a guest application on the guest system; and
causing the guest application to be provided with access to directly control the device as if the device were present on the guest system, wherein control of the device is concurrently shared between the guest application and the host system, and wherein a driver specific to the device is not implemented on the guest system.

2. The method of claim 1, wherein the guest system comprises a virtualized system running on top of the host system.

3. The method of claim 1, wherein the guest system comprises a first physical machine separate from a second physical machine on which the host system is implemented, wherein communication between the guest system and the host system is enabled by way of a connection between the first and second physical machines.

4. The method of claim 1,wherein providing the devirtualization server driver comprises providing a devirtualization server driver integrated into a kernel of an operating system implemented on the host system, and wherein the devirtualization client driver is integrated into a kernel of an operating system implemented on the guest system.

5. The method of claim 1, wherein receiving the request comprises receiving a hypercall from the devirtualization client driver to the devirtualization server driver.

6. The method of claim 1, wherein causing the guest application to be provided with access to directly control the device as if the device were present on the guest system comprises:
causing the devirtualization server driver to place a call to the device using one or more parameters included in the request received from the devirtualization client driver; and
in an instance in which the call to the device is successful, causing the devirtualization server driver to send a message to the devirtualization client driver to inform the devirtualization client driver that the request was successful.

7. The method of claim 6, further comprising:
receiving, at the devirtualization client driver, the message sent by the devirtualization server driver informing that the request was successful; and
causing the devirtualization client driver to return an anonymous file descriptor to the guest application, wherein the anonymous file descriptor includes one or more overloaded virtual file system operations to remote the one or more file operations to the devirtualization server driver such that future calls to the device by the guest application are peered via the anonymous file descriptor to the devirtualization server driver to enable the guest application to directly control the device as if the device were present on the guest system.

8. The method of claim 1, wherein the devirtualization client driver is configured to enable the guest application to directly control the device as if the device were present on the guest system by creating an anonymous file descriptor and returning the anonymous file descriptor to the guest application in response to a message from the devirtualization driver host that the request was successful, wherein the anonymous file descriptor includes one or more overloaded virtual file system operations to remote the one or more file operations to the devirtualization server driver such that future calls to the device by the guest application are peered via the anonymous file descriptor to the devirtualization server driver.

9. The method of claim 1, further comprising:
causing the host system to maintain a merged address space for a host operating system kernel and a guest user address space used by the guest application; and
using the merged address space for any memory operations performed in response to a call from the guest application to control the device.

10. An apparatus comprising at least one processor and at least one memory storing computer program code, wherein the at least one memory and stored computer program code are configured, with the at least one processor, to cause the apparatus to at least:
provide a devirtualization server driver on a host system;
receive, at the devirtualization server driver, a request from a devirtualization client driver on a guest system for access to a physical device implemented on the host system, the request being associated with a guest application on the guest system; and
cause the guest application to be provided with access to directly control the device as if the device were present on the guest system, wherein control of the device is concurrently shared between the guest application and the host system, and wherein a driver specific to the device is not implemented on the guest system.

11. The apparatus of claim 10, wherein the guest system comprises a virtualized system running on top of the host system.

12. The apparatus of claim 10, wherein the guest system comprises a first physical machine separate from a second physical machine on which the host system is implemented, wherein the apparatus is implemented on the second physical machine, and wherein communication between the guest system and the host system is enabled by way of a connection between the first and second physical machines.

13. The apparatus of claim 10, wherein the at least one memory and stored computer program code are configured, with the at least one processor, to further cause the apparatus to provide the devirtualization server driver at least in part by providing a devirtualization server driver integrated into a kernel of an operating system implemented on the host system, and wherein the devirtualization client driver is integrated into a kernel of an operating system implemented on the guest system.

14. The apparatus of claim 10, wherein the at least one memory and stored computer program code are configured, with the at least one processor, to further cause the apparatus to receive the request at least in part by receiving a hypercall from the devirtualization client driver to the devirtualization server driver.

15. The apparatus of claim 10, wherein the at least one memory and stored computer program code are configured, with the at least one processor, to further cause the apparatus to cause the guest application to be provided with access to directly control the device as if the device were present on the guest system at least in part by:
causing the devirtualization server driver to place a call to the device using one or more parameters included in the request received from the devirtualization client driver; and
in an instance in which the call to the device is successful, causing the devirtualization server driver to send a message to the devirtualization client driver to inform the devirtualization client driver that the request was successful.

16. The apparatus of claim 10, wherein the at least one memory and stored computer program code are configured, with the at least one processor, to further cause the apparatus to:
receive, at the devirtualization client driver, the message sent by the devirtualization server driver informing that the request was successful; and
cause the devirtualization client driver to return an anonymous file descriptor to the guest application, wherein the anonymous file descriptor includes one or more overloaded virtual file system operations to remote the one or more file operations to the devirtualization server driver such that future calls to the device by the guest application are peered via the anonymous file descriptor to the devirtualization server driver to enable the guest application to directly control the device as if the device were present on the guest system.

17. The apparatus of claim 10, wherein the devirtualization client driver is configured to enable the guest application to directly control the device as if the device were present on the guest system by creating an anonymous file descriptor and returning the anonymous file descriptor to the guest application in response to a message from the devirtualization driver host that the request was successful, wherein the anonymous file descriptor includes one or more overloaded virtual file system operations to remote the one or more file operations to the devirtualization server driver such that future calls to the device by the guest application are peered via the anonymous file descriptor to the devirtualization server driver.

18. The apparatus of claim 10, wherein the at least one memory and stored computer program code are configured, with the at least one processor, to further cause the apparatus to:
cause the host system to maintain a merged address space for a host operating system kernel and a guest user address space used by the guest application; and
use the merged address space for any memory operations performed in response to a call from the guest application to control the device.

19. The apparatus of claim 10, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

20. A computer program product comprising at least one non-transitory computer-readable storage medium having computer-readable program instructions stored therein, the computer-readable program instructions comprising program instructions, which when performed by an apparatus, are configured to cause the apparatus to at least:
provide a devirtualization server driver on a host system;
receive, at the devirtualization server driver, a request from a devirtualization client driver on a guest system for access to a physical device implemented on the host system, the request being associated with a guest application on the guest system; and
cause the guest application to be provided with access to directly control the device as if the device were present on the guest system, wherein control of the device is concurrently shared between the guest application and the host system, and wherein a driver specific to the device is not implemented on the guest system.
